(19) United States
(12) Patent Application Publication
(10) Pub. No.: US 2024/0206014 A1
(43) Pub. Date: Jun. 20, 2024

(54) METHOD, APPARATUS AND SYSTEM FOR IMPROVED DIRECTIONAL MULTIGIGABIT SENSING

(71) Applicant: HUAWEI TECHNOLOGIES CO., LTD., SHENZHEN (CN)

(72) Inventors: Yan XIN, Kanata (CA); Osama ABOUL-MAGD, Kanata (CA); Jung Hoon SUH, Kanata (CA); Michael MONTEMURRO, Kanata (CA); Kwok Shum AU, Kanata (CA); Stephen MCCANN, Kanata (CA)

(73) Assignee: HUAWEI TECHNOLOGIES CO., LTD., SHENZHEN (CN)

(21) Appl. No.: 18/068,040

(22) Filed: Dec. 19, 2022

(51) Int. Cl. H04W 84/12; H04W 24/10

(52) U.S. Cl. CPC H04W 84/12; H04W 24/10

(57) ABSTRACT

Efficient and accurate sensing measurements and reporting with multiple responders in 60 GHz WLAN is accomplished by conducting the measurements and reporting in multiple sub-channels separated in a frequency domain, or in a space domain, or both. Measurements, via sensing PPDUs, can be transmitted in parallel in time by multiple devices. Messaging related to communicating reporting of sensing results can also be transmitted in parallel in time by multiple devices. This parallelization is facilitated by the use of the multiple sub-channels in frequency or spatial domain.

### CROSS-REFERENCE TO RELATED APPLICATIONS

This is the first application filed for the present invention.

### FIELD OF THE INVENTION

The present invention pertains to the field of object sensing using radio signals in wireless local area networks such as IEEE 802.11 networks with directional multigigabit capabilities, and in particular to methods, apparatus and systems for improved directional multigigabit object sensing in such a context.

### BACKGROUND

IEEE 802.11bf is an ongoing task group associated with development of the IEEE 802.11 standard. This task group is working on an amendment of the 802.11 standard for wireless local area network (WLAN) object sensing. As described in the document “IEEE 802.11-19/2103r12, 802.11 SENS SG proposed PAR,” available via https://mentor.ieee.org, this amendment defines the modifications to the IEEE 802.11 medium access control (MAC) layer and to the physical (PHY) layer of directional multigigabit (DMG)/enhanced directional multigigabit (EDMG) operations to enhance the WLAN sensing operation in the unlicensed radio frequency bands between 1 GHz and 7.125 GHZ (sub-7 GHZ) and around 60 GHz. IEEE 802.11bf amends IEEE 802.11-2020 and also considers the High Efficiency (HE) (see IEEE 802.11ax) and Extremely High Throughput (EHT) (see IEEE 802.11be) aspects of the IEEE 802.11 standard in the sub-7 GHz band, and DMG/EDMG (see IEEE 802.11ad/802.11ay) in the 60 GHz band for the sensing applications.

As defined in the IEEE 802.11bf draft standard document entitled “IEEE P802.11bf/D0.4” available at https://standards.ieee.org, WLAN sensing uses the PHY and MAC radio signal transmission and reception capabilities of IEEE 802.11 stations (STAs) to obtain measurements that may be used to estimate features such as range, velocity, and motion of objects in an area of interest.

In the HE and EHT aspects of IEEE 802.11, an efficient multiplexing method of orthogonal frequency division multiple access (OFDMA) is specified. However, in DMG/EDMG, OFDMA is not specified. Accordingly, at present, the sensing procedure defined for the sub-7 GHz operation cannot be fully applied to that for the 60 GHz operation.

Furthermore, DMG sensing that operates in the 60 GHz band is categorized for: monostatic, coordinated monostatic, bistatic, coordinated bistatic, multistatic and passive sensing. However, the sensing procedure proposed by the IEEE 802.11bf task group so far, for coordinated monostatic, coordinated bistatic and multistatic sensing, considers only serial sensing measurement and sensing reporting. This may lead to inaccurate measurement results when the measurement reports obtained from multiple coordinated STAs are combined, and an inefficient reporting procedure. The current proposed standard is therefore subject to various improvements.

Therefore, there is a need for a method, apparatus and systems that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide methods, apparatus and systems for improved directional multigigabit sensing, for example compatible with sensing operations being developed by the IEEE 802.11bf task group, or more generally being compliant with present or future versions of the IEEE 802.11 standard. Embodiments described herein relate to applying multiple sub-channels, multiple antennas, or both, to the 60 GHz WLAN sensing approach of the IEEE 802.11bf for efficient and accurate sensing measurement, efficient sensing reporting with multiple responders, or both. Embodiments described herein may additionally or alternatively apply to future extensions of IEEE 802.11bf, for example to allow operation in the Chinese 59-64 GHz frequency bands. Sensing measurements made by different STAs can be performed concurrently (in parallel). Sensing reports from different STAs can also be made concurrently (in parallel). Various embodiments relate to one, some or all of the coordinated monostatic, coordinated bistatic, and multistatic sensing applications with multiple transmitters, multiple responders, or both.

Rather than being restricted to serial sensing measurements and sensing reporting (for coordinated monostatic, coordinated bistatic and multistatic sensing), embodiments provide for alternative, less restrictive sensing and reporting approaches. A technical effect of such embodiments is that, when the channel condition, the targeting object to be detected, or both, change, measurement results may be more readily or accurately combined, because they may correspond to measurements at the same (or closer, or overlapping) times, as obtained by STAs performing the measurements in coordination. Another technical effect is that a parallel reporting procedure can be implemented, which is potentially more efficient than the prior serial reporting procedure.

According to embodiments of the present invention, there is provided a system, an apparatus and a method for sensing an object using wireless signals.

Some embodiments provide for a system that may include a sensing initiator and a plurality of sensing responders. The sensing initiator and the sensing responders of the system may be configured to wirelessly communicate to set up an object sensing measurement; and after setting up the object sensing measurement, cooperate to transmit a plurality of sensing physical layer protocol data units (PPDUs) on a plurality of sub-channels, and obtain measurements of the plurality of sub-channels in order to estimate one or more physical characteristics of the object based on receipt of the sensing PPDUs. In this system, different sub-channels of the plurality of sub-channels may be different from one another in respect to carrier frequency and non-overlapping in frequency domain, or in respect to non-overlapping in space, or both. Each of the sensing PPDUs may be transmitted parallel in time. Some other embodiments disclose a system that may comprise a sensing initiator and a plurality of sensing responders. The sensing initiator and the sensing responders may be configured to wirelessly communicate to set up an object sensing measurement, and, after setting up the object sensing measurement, cooperate to transmit one or more sensing PPDUs, and to obtain measurements in order to estimate one or more physical characteristics of the object. After obtaining the measurements, each of the sensing responders may report to the sensing initiator, respective information obtained from the measurements (also referred to herein as indications of measurements), and reporting of the respective information may be performed in parallel in time by each of the sensing responders. The measurements may be obtained based on receipt of the one or more sensing PPDUs.

Embodiments include wirelessly communicating between a sensing initiator and a plurality of sensing responders to set up an object sensing measurement. Wirelessly communicating between the sensing initiator and the plurality of sensing responders to set up the object sensing measurement may comprise the sensing initiator communicating with each one of the sensing responders using a different respective directed and spatially separate wireless communication stream. The method may further include by cooperation of the sensing initiator and each of the sensing responders transmitting, with respect to each of the sensing responders, a different respective sensing PPDU frame on a different respective one of a plurality of sub-channels. The different respective sub-channels are different from one another with respect to carrier frequency and non-overlapping in a frequency domain. The method may further include obtaining measurements of the plurality of sub-channels in order to estimate one or more physical characteristics of the object based on receipt of the sensing PPDU frames. Each of the plurality of sensing responders may transmit one or more of the sensing PPDU frames. Each of the plurality of sensing responders may also measure one of the different respective sub-channels to receive a corresponding one of the sensing PPDUs as part of obtaining measurements. The sensing initiator in some embodiments may transmit each one of the sensing PPDUs, and each of the plurality of sensing responders may measure one of the different respective sub-channels to receive its respective sensing PPDU as part of said obtaining measurements. In some embodiments of the system, apparatus, and method, each of the different respective sensing PPDUs are transmitted in parallel. Transmitting each of the different respective sensing PPDUs in parallel may comprise transmitting each of the different respective sensing PPDUs with at least partially overlapping timing with at least one other of the different respective sensing PPDUs.

Some embodiments of the system, apparatus, and method may further include reporting by each of the sensing responders respective information obtained from said monitoring (or measurements) to the sensing initiator.

The sensing initiator may measure each of the different respective sub-channels to receive the sensing PPDUs as part of said obtaining measurements. Each of the sensing responders may also report the respective information using one of the plurality of sub-channels. The different sensing responders may use different ones of the plurality of sub-channels. The respective information may be reported in parallel by each of the sensing responders. The respective information reporting in parallel by each of the sensing responders may comprise reporting the respective information with at least partially overlapping timing with said reporting the respective information by at least one other of the sensing responders respective information. The sensing initiator may transmit, to each one of the different sensing responders, a respective prompt (a poll) requesting to report the respective information, a respective acknowledgement (ACK) of said reporting the respective information, or both, wherein each respective prompt (poll), each respective acknowledgement, or both, is transmitted in parallel using the different one of the plurality of sub-channels used by the one of the different sensing responders to perform said reporting the respective information.

Reporting the respective information may be performed at a different respective time by each of the sensing responders. Each of the sensing responders may report the respective information using a different respective directed and spatially separate wireless communication stream. The respective information reporting may be performed in parallel by each of the sensing responders. In some embodiments of the system and method, the respective information reporting in parallel may comprise each of the sensing responders reporting the respective information with at least partially overlapping timing with said reporting the respective information by at least one other of the sensing responders. Furthermore, in some embodiments, the sensing initiator may transmit to each one of the plurality of sensing responders a respective prompt (a respective poll) to report the respective information, a respective acknowledgement (ACK) of said reporting the respective information, or both. Each respective prompt (poll), each respective acknowledgement, or both, is transmitted in parallel using, in reverse, the different respective directed and spatially separate wireless communication stream used by the one of the plurality of sensing responders to perform said reporting the respective information. Each of the sensing responders may also communicate with the sensing initiator, as part of said setting up the object sensing measurement, using the different respective directed and spatially separate wireless communication stream.

Yet other embodiments of the system and method for sensing an object using wireless signals, may comprise wirelessly communicating between a sensing initiator and a plurality of sensing responders to set up an object sensing measurement. The system and method may further comprise by cooperation of the sensing initiator and each of the sensing responders transmitting one or more sensing PPDUs and obtaining measurements in order to estimate one or more physical characteristics of the object. The measurements are obtained via interaction with the one or more sensing PPDU frames. Each of the sensing responders reports respective information obtained from monitoring to the sensing initiator. Reporting of the respective information may be performed in parallel by each of the sensing responders. Reporting of the respective information in parallel may comprise each of the sensing responders reporting the respective information with at least partially overlapping timing with said reporting the respective information by at least one other of the sensing responders.

Each of the sensing responders may report the respective information to the sensing initiator using a different respective one of a plurality of sub-channels, the sub-channels differing from one another with respect to carrier frequency. Each of the sensing responders may use the respective one of the plurality of sub-channels to perform its own respective portion of said transmitting the one or more sensing PPDUs, or its own respective portion of said monitoring for wireless signatures, or both.

Some embodiments of the present invention disclose a device acting as a sensing initiator or a sensing responder, and an associated method. The device may wirelessly communicate with one or more other devices to set up an object sensing measurement, wherein the device and the one or more other devices constitute the sensing initiator and one or more sensing responders, including the sensing responder. The device may further transmit a sensing PPDU, or monitoring for a wireless signature indicative of physical characteristics of the object due to the sensing PPDU, or both. The device may cooperate with the one or more other devices to transmit, with respect to each of the sensing responders, a different respective sensing PPDU, including the sensing PPDU, on a different respective one of a plurality of sub-channels. The sub-channels may differ from one another with respect to carrier frequency which are non-overlapping in frequency domain, and may obtaining measurements of the plurality of sub-channels in order to estimate one or more physical characteristics of the object based on receipt of the sensing PPDUs. Each of the sensing responders may report respective information obtained from said measurements to the sensing initiator, and each of the different respective sensing PPDUs may be transmitted in parallel in time.

Some other embodiments disclose a device acting as a sensing initiator or a sensing responder, and an associated method. The device may wirelessly communicate with one or more other devices to set up an object sensing measurement. The device and the one or more other devices constitute the sensing initiator and one or more sensing responders, including the sensing responder. The device may transmit a sensing PPDU, or obtaining measurements in order to estimate one or more physical characteristics of an object based on receipt of the sensing PPDUs. The device may perform both: transmitting sensing PPDUs and obtaining measurements. The device may further report information obtained from monitoring to the sensing initiator, or monitoring for reporting containing the information. Reporting of the information may be performed in parallel by each of the sensing responders. Each of the sensing responders may report the respective information to the sensing initiator using a different respective one of a plurality of sub-channels, the sub-channels differing from one another with respect to carrier frequency. Each of the sensing responders may also report the respective information to the sensing initiator using a different respective directed and spatially separate wireless communication path.

Some embodiments provide for a method for sensing an object using wireless signals, as performed by a sensing initiator. The method includes wirelessly communicating with a plurality of sensing responders to set up an object sensing measurement. The method further includes transmitting, to each of the sensing responders, or receiving from each of the sensing responders, a different respective sensing PPDU on a different respective one of a plurality of sub-channels. The different respective sensing PPDUs are transmitted in parallel in time. The different respective sub-channels differ from one another with respect to carrier frequency and are non-overlapping in frequency domain. The method includes obtaining indications of measurements of the plurality of sub-channels based on receipt of the sensing PPDUs by the sensing initiator, or based on receipt of reports from the plurality of sensing responders. The reports are generated based on receipt of the sensing PPDUs. The indications of measurements are usable to estimate one or more physical characteristics of the object. A sensing initiator apparatus configured to perform operations commensurate with the above method is also provided.

Some embodiments provide for a method for sensing an object using wireless signals by a sensing responder. The method includes wirelessly communicating with a sensing initiator to set up an object sensing measurement. The object sensing measurement involves the sensing initiator, the sensing responder, and one or more other sensing responders. The method includes transmitting a sensing PPDU on one of a plurality of sub-channels. The sensing PPDU is transmitted in parallel in time with one or more other sensing PPDUs each transmitted by a respective one of the other sensing responders on another one of the plurality of sub-channels. The plurality of sub-channels differ from one another with respect to carrier frequency and are non-overlapping in frequency domain. In some embodiments, the method further includes obtaining measurements of the one of the plurality of sub-channels in order to estimate one or more physical characteristics of the object based on receipt of the sensing PPDU, and reporting an indication of such measurements to the sensing initiator. A sensing responder apparatus configured to perform operations commensurate with the above method is also provided.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates coordinated monostatic sensing with one initiator and two responders in accordance with embodiments of the present disclosure.

FIG. 2 illustrates a procedure for coordinated monostatic sensing.

FIG. 3 illustrates coordinated bistatic sensing with one initiator and two responders.

FIG. 4 illustrates a procedure for coordinated bistatic sensing.

FIG. 5-1 is an example of multistatic sensing with one transmitter (initiator) and two receivers (responders).

FIG. 5-2 illustrates an example of multistatic sensing with two transmitters (responders) and one receiver (initiator).

FIG. 6 illustrates a procedure for multistatic sensing.

FIG. 7 is an illustration of multi-sub-channel operation in IEEE 802.11ay.

FIG. 8 illustrates a procedure of monostatic sensing with coordination in accordance with some embodiments of the present disclosure.

FIG. 9 illustrates a procedure of monostatic sensing with coordination in accordance with other embodiments.

FIG. 10 illustrates a procedure of monostatic sensing with coordination in accordance with yet other embodiments.

FIG. 11 illustrates a procedure of monostatic sensing with coordination in accordance with further embodiments.

FIG. 12 shows a procedure of bistatic sensing with coordination in accordance with respective embodiments.

FIG. 13 is another example of bistatic sensing with coordination in accordance with some embodiments.

FIG. 14 illustrates yet another procedure of bistatic sensing with coordination in accordance with some other embodiments.

FIG. 15 is another example of a bistatic sensing procedure.

FIG. 16 is an example of a multistatic sensing procedure in accordance with some embodiments.

FIG. 17 is another example of a multistatic sensing procedure in accordance with other embodiments.

FIG. 18 illustrates a multistatic sensing procedure in accordance with further embodiments.

FIG. 19 is a multistatic sensing procedure in accordance with yet other embodiments.

FIG. 20 illustrates an electronic device acting as a sensing initiator or a sensing responder according to embodiments of the present disclosure.

FIG. 21 illustrates another aspect of an electronic device acting as a sensing initiator or a sensing responder according to embodiments of the present disclosure.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The numbers and numbers combined with letters correspond to the component labels in all the figures.

As used herein, the term “in parallel” refers to two events, such as transmissions, that occur in parallel in time, for example so as to be simultaneous, or overlapping, or concurrent, at least in part. Two events which occur in parallel (in time) may be substantially exactly simultaneous, so that their beginnings and endings align more or less exactly in time. However, it is also contemplated that two events which occur in parallel (in time) are not necessarily exactly simultaneous. Rather, the two events may instead occur with at least partially overlapping timing with respect to one another, so that at some point in time both events are occurring, but the beginnings, endings, or both, of the two events do not necessarily align in time.

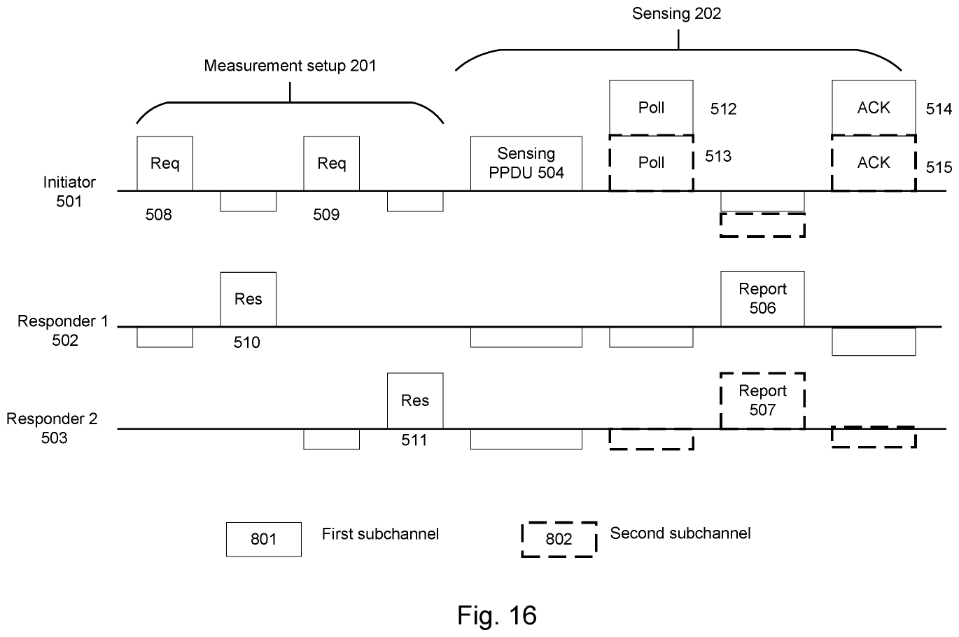

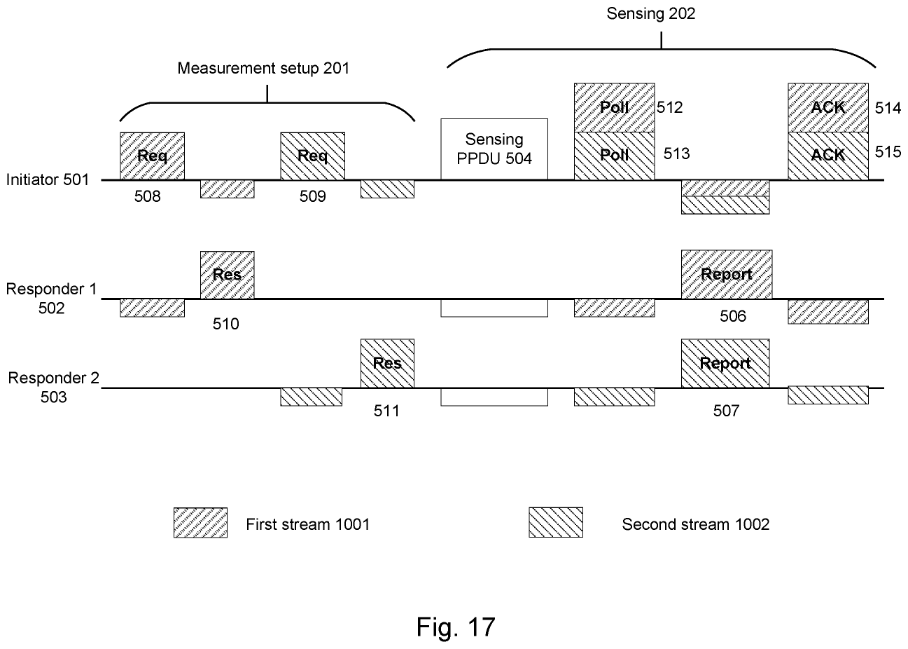

In the various embodiments described below (except for those of FIGS. 16 and 17 where only one sensing PPDU is transmitted), sensing PPDUs are transmitted in parallel (in time). In several embodiments, frames associated with reporting such as Poll, Report and/or ACK frames are also transmitted in parallel (in time) by more than one device.

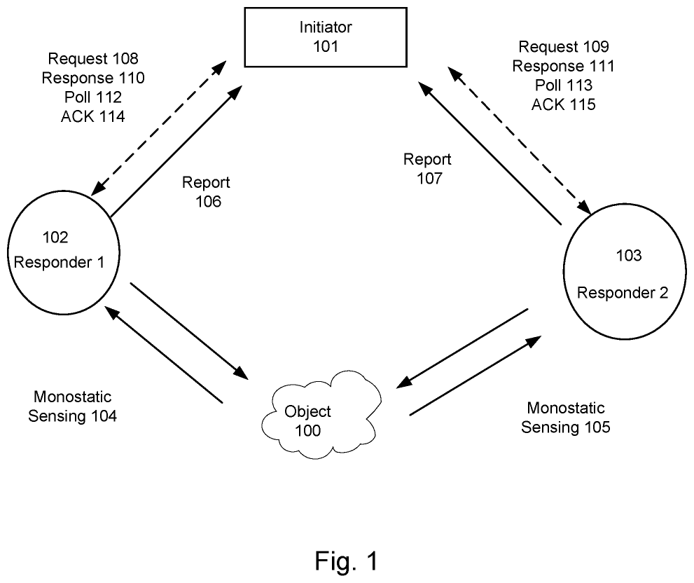

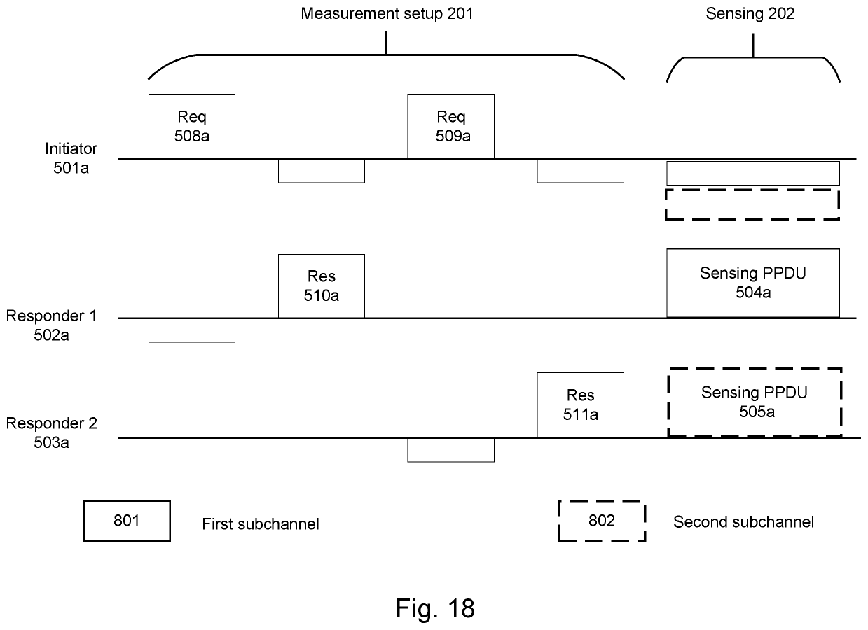

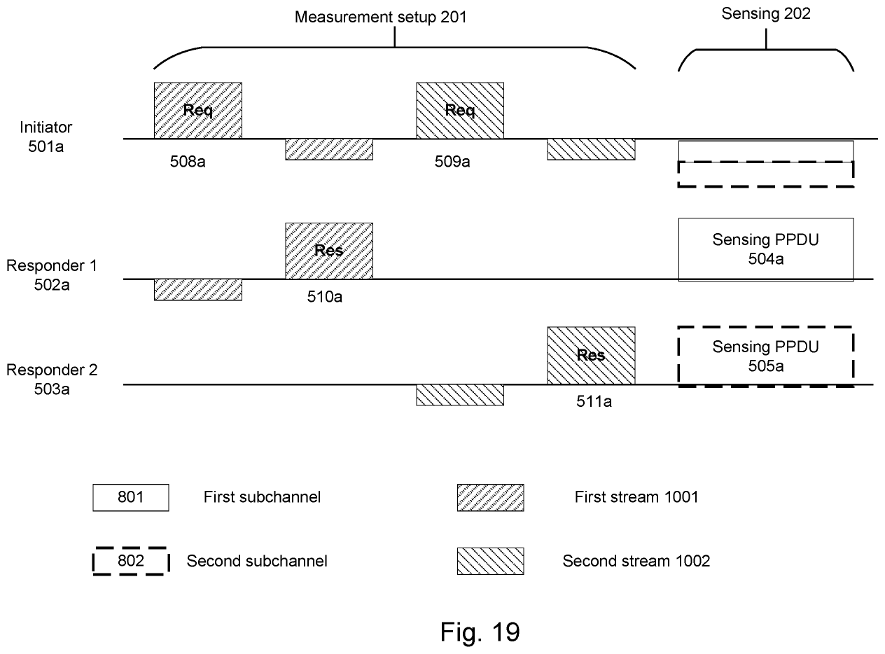

Before describing embodiments of the disclosure in detail, a brief overview of different IEEE 802.11bf sensing modalities in general is provided. Each modality uses wireless signals, e.g. in the form of a sensing PPDU, to sense an object, which may include sensing physical characteristics of the object. Sensing PPDUs may also be referred to as sounding PPDUs. Physical characteristics may include, for example, size, shape, orientation, motion, materials, pose, or the like, or a combination thereof. The sensing PPDU is transmitted wirelessly in compliance with IEEE 802.11 protocols and in a certain frequency band. The object absorbs, reflects, or otherwise interacts with the radio signals carrying the sensing PPDU, such that the sensing PPDU is modified. The sensing PPDU is then received and processed to determine the presence and characteristics of such modifications. Based on this, the physical characteristics of the object are estimated. It should be noted that the general sensing setups of FIGS. 1, 3, 5-1 and 5-2 apply to sensing setups according to embodiments of the present disclosure. In monostatic, bistatic, and some forms of multistatic sensing, the responders each obtain measurements of a channel or sub-channel by receiving and processing at least one of the sensing PPDUs. In other forms of multistatic sensing, for example as illustrated in FIGS. 18 and 19, the initiator obtains the measurements. This allows the initiator to estimate the physical characteristics of the object.

A monostatic sensing device may be a device in which a sensing PPDU transmitter and a sensing PPDU receiver are collocated in the same station (STA). FIG. 1 shows coordinated monostatic sensing with one initiator 101 and two responders 102 and 103, for sensing an object 100. The various messages (which may be frames) are described in more detail with respect to other drawings. Each of the responders 102, 103 performs sensing by transmitting and receiving a respective sensing PPDU upon request from the initiator 101, and responds to the initiator 101 with the results of the sensing. Receiving a sensing PPDU may involve measuring the characteristics of a designated channel or sub-channel through the use of a receiver.

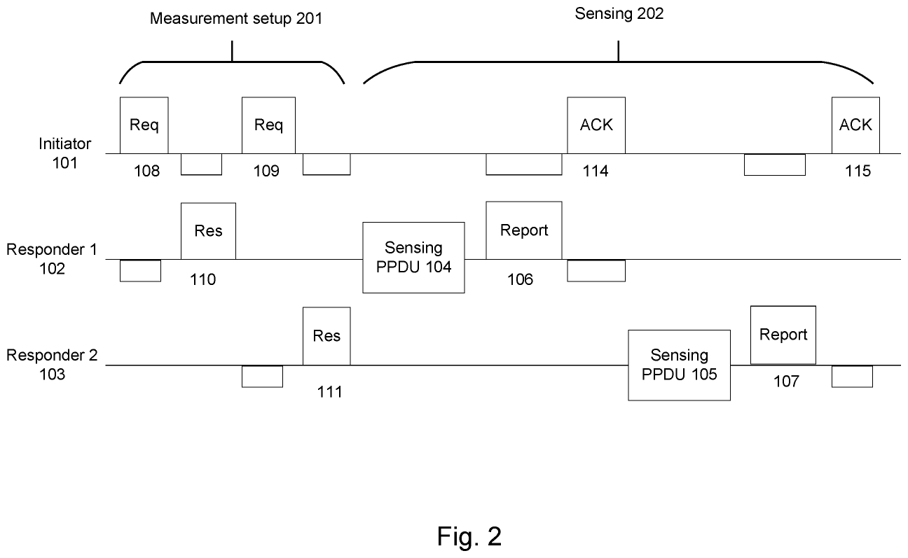

FIG. 2 illustrates a procedure for coordinated monostatic sensing involving transmitting and receiving physical layer protocol data units (PPDUs) and sensing reporting as outlined in IEEE 802.11-22/0243r06. The procedure includes a measurement setup phase 201, and a sensing phase 202. During the measurement setup phase 201, the initiator 101 wirelessly communicates with a plurality of sensing responders (102 and 103) to set up an object sensing measurement. The initiator 101 transmits sequentially request frames 108 and 109 to the responders 102 and 103 respectively. Upon receipt of the request frames 108 and 109, responders 102 and 103 finalize a handshake procedure by replying back to the initiator 101 with response frames 110 and 111, respectively. Request and response frames are exchanged between the initiator 101 and responders 102 and 103 sequentially over a single sub-channel. During the sensing phase 202, responders 102 and 103 perform measurements on the object 100 by transmitting and receiving sensing PPDUs 104 and 105, respectively. In FIGS. 1 and 2, the sensing PPDUs 104 and 105 are transmitted at different times. Upon finalizing transmitting and receiving sensing PPDUs 104 and 105, responders 102 and 103 submit to the initiator 101 measurement reports 106 and 107 respectively. In FIGS. 1 and 2, the measurement reports 106 and 107 are transmitted at different times, for example following their respective sensing PPDUs. As noted above, the responders 102 and 103 perform measurements at different time instances. This may cause inaccurate measurement results when the initiator 101 combines the measurement reports 106 and 107 from responders 102 and 103, for example due to different channel conditions during transmission of the different sensing PPDUs. In addition, the sequential transmission of measurement reports is time-consuming.

In FIG. 2 and similar drawings, transmission of a frame is illustrated by a corresponding rectangle drawn above a line extending horizontally from a device performing the transmission. For example, the initiator 101 transmits a request 108. Reception of the same frame is illustrated by a corresponding rectangle drawn below a line extending horizontally from a device performing the reception. For example, the responder 102 receives the request 108. For monostatic sensing, the sensing PPDU is transmitted and received by the same device (STA), and hence such a sensing PPDU is represented using a rectangle extending both above and below a horizontal line, for example as shown for PPDU 104.

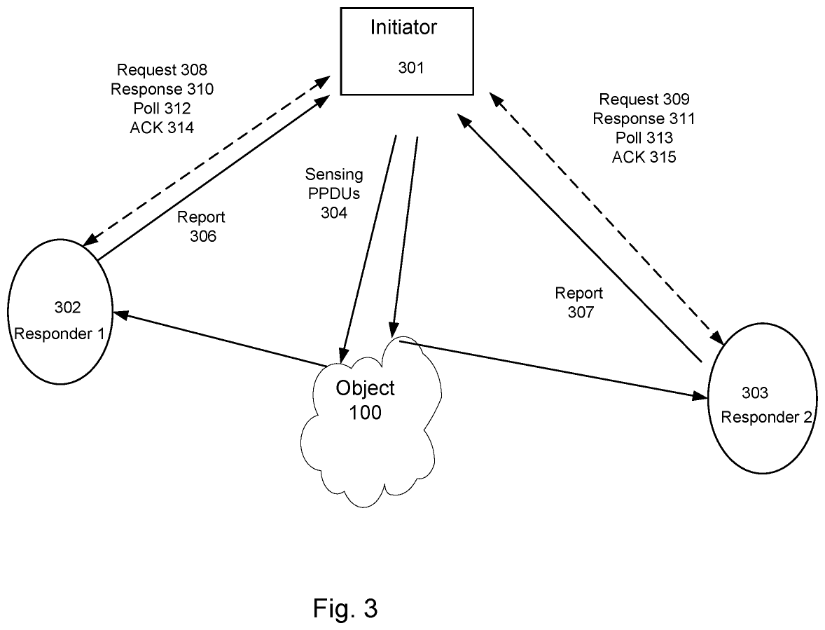

A bistatic sensing device may be a device where a sensing PPDU is transmitted by one station (STA) and received by another station. In some cases one station can transmit multiple sensing PPDUs, each for receipt by a different other station. Bistatic sensing with coordination includes coordination of multiple bistatic responders. FIG. 3 shows coordinated bistatic sensing with one initiator 301 and two responders 302 and 303, for sensing the object 100. The various messages (frames) are described in more detail with respect to other drawings. Following measurement setup, each of the responders 302, 303 receives a sensing PPDU transmitted by the initiator 301 and responds to the initiator 101 with results due to such reception.

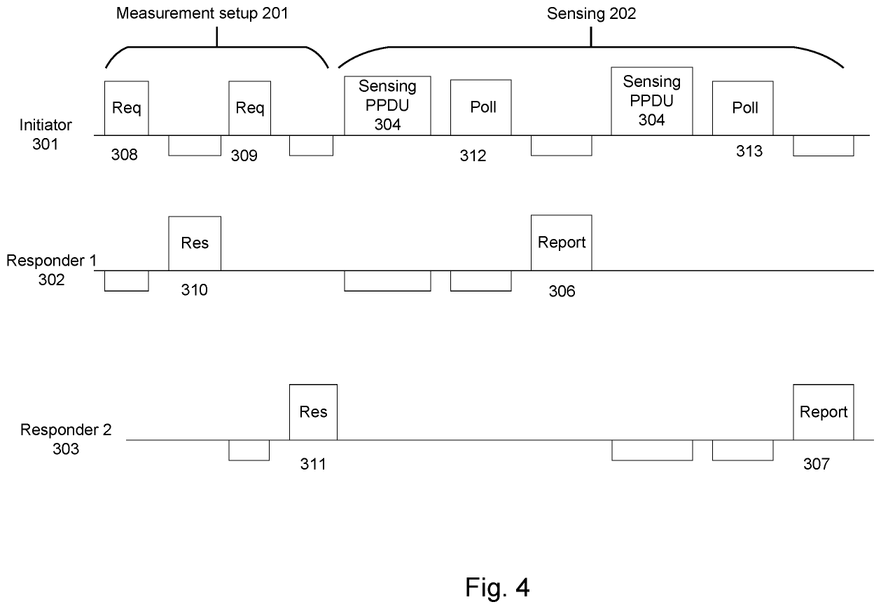

FIG. 4 illustrates a procedure for coordinated bistatic sensing with sequential sensing measurement and sensing reporting as outlined in IEEE 802.11-22/0243r06. The procedure includes a measurement setup phase 201, and a sensing phase 202. The measurement setup phase 201 of FIG. 4 is identical in form to the measurement setup phase 201 disclosed in FIG. 2 except for the numbering of the frames. During the sensing phase 202, the initiator 301 transmits multiple sensing PPDUs 304 at different times. Responders 302 and 303 perform measurements of PPDUs 304, and submit measurement reports 306 and 307, respectively, back to initiator 301. Measurement reports 306 and 307 are transmitted sequentially. As the responders 302 and 303 perform measurements at different time instances, it may cause inaccurate measurement results when initiator 301 combines the measurement reports from responders 302 and 302. Sequential reporting is also time-consuming.

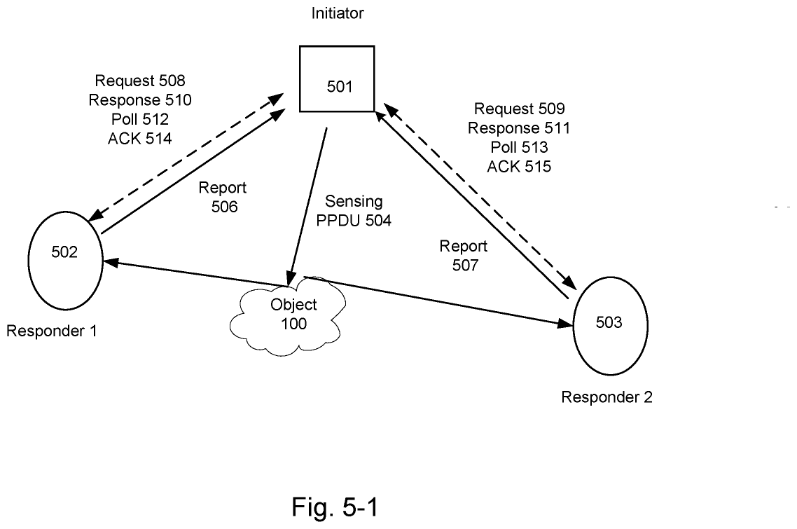

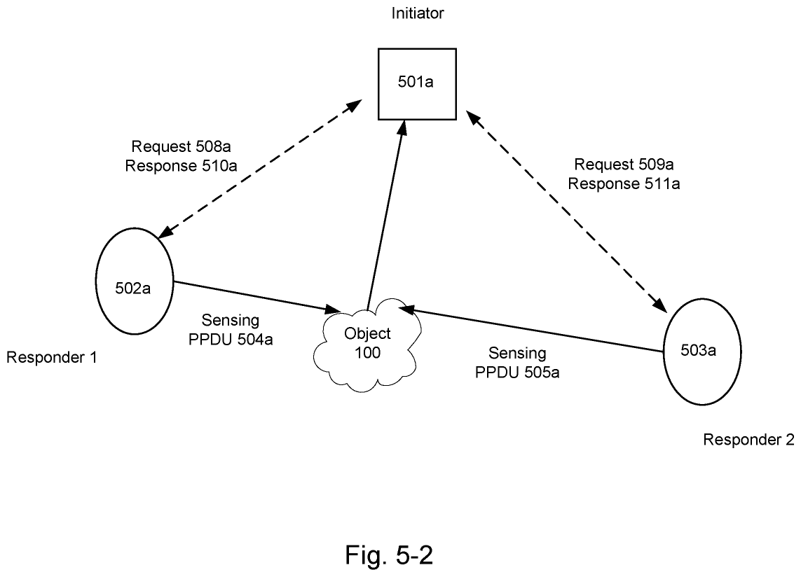

Multi-static sensing may be defined as a system with at least three STAs, for example, one receiver and two transmitters, or two receivers and one transmitter. A multi-static sensing system may also include multiple receivers and multiple transmitters. This may be viewed as a generalization of the bistatic sensing system. For example, FIG. 5-1 illustrates a multistatic sensing system with one transmitter (initiator 501) and two receivers—502 and 503, for sensing the object 100. The various messages (frames) are described in more detail with respect to other drawings.

FIG. 5-2 shows another multistatic sensing system with two transmitters 502a and 503a and a receiver (initiator 501a), for sensing the object 100. The various frames are described in more detail with respect to other drawings. Responders 502a and 503a may transmit sensing PPDU 504a and 505a at different time instances, respectively. As before, this may cause inaccurate measurement results when initiator 501a combines the received measurements.

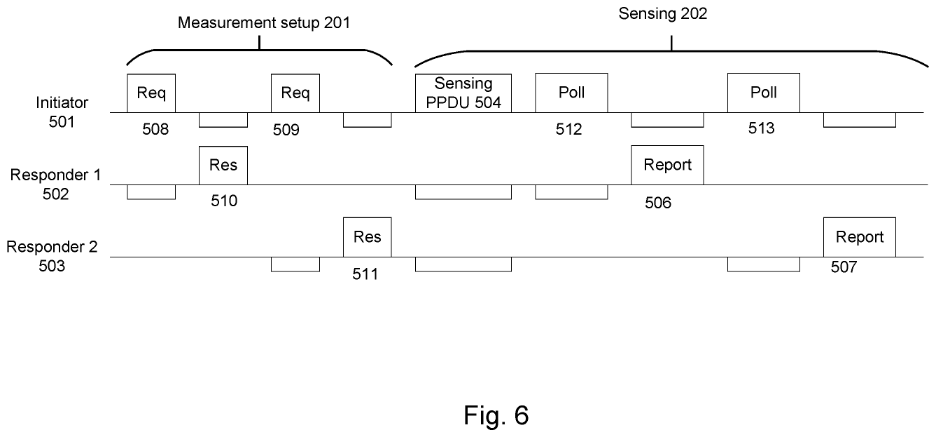

FIG. 6 illustrates a procedure for multistatic sensing and sequential sensing reporting. The measurement setup phase 201 of this procedure is identical in form to the one disclosed in FIG. 2. During the sensing phase 202 the initiator 501 transmits sensing PPDU 504. Responders 502 and 503 both receive the same sensing PPDU 504. Following the receipt of sensing PPDU 504, responders 502 and 503 may submit to initiator 501 measurement reports 506 and 507 respectively. Even though the initiator 501 transmits single sensing PPDU 504, the measurement reports 506 and 507 may be still transmitted sequentially as shown in FIG. 6. Thus, the reporting may be more time consuming than necessary, because time-parallel reporting is not employed in this procedure. Initiator 501 may time measurement reports 506 and 507 submission by dispatching poll frames 512 and 513 to responders 502 and 503 respectively.

Under IEEE 802.11ay, an EDMG STA shall support 4.32 GHZ (two contiguous 2.16 GHZ sub-channels) for PPDU transmission using EDMG Control mode (MCS 0) and SC mode (MCS 1-5 and 7-10). An EDMG station (STA) may support 2.16+2.16 GHZ sub-channels (i.e. two contiguous or non-contiguous sub-channels) for PPDU transmission using EDMG control mode MCS 0, SC mode, and OFDM mode (all MCSs). An EDMG access point (AP) may transmit a DMG Beacon frame using a quasi-omnidirectional antenna pattern. An EDMG AP may allocate an A-BFT over the primary channel and may also allocate an A-BFT over a secondary channel. Therefore, two non-AP STAs may transmit sector sweep (SSW) frames and SSW Feedback frames in parallel in time over the primary and the secondary channel, respectively.

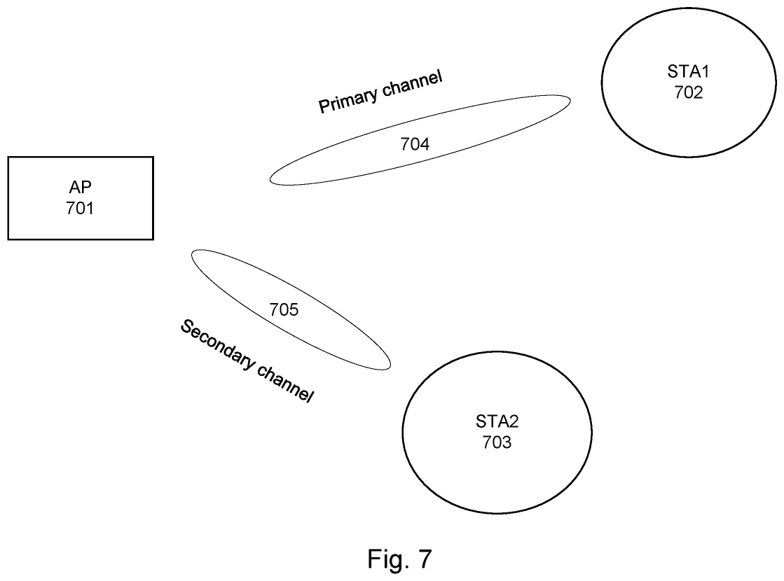

Under IEEE 802.11ay, an access point (AP) 701 may communicate with a non-AP STA1 702 and a non-AP STA2 703 in parallel through a primary channel 704 and a secondary channel 705, respectively, as illustrated in FIG. 7. The IEEE 802.11ay standard specifies a downlink (DL) of a multi-user multiple-input multiple-output (MU-MIMO). Implementation of the MU-MIMO DL feature enables an access point (AP) to transmit N PPDU frames to N users through N spatial streams in parallel. Both multi-sub-channel and DL MU-MIMO features facilitate implementation of efficient and accurate coordinated monostatic, bistatic and multistatic sensing as disclosed in the following embodiments. In other words, embodiments of the present disclosure utilize multiple channels (in different frequency sub-channels) for communicating between a sensing initiator and sensing responders. These sub-channels may be described as being different with respect to carrier frequency and non-overlapping in the frequency domain. This use of multiple channels is supported by the IEEE standard as noted above, and allows for parallel transmission of multiple sensing PPDUs, parallel reporting of sensing results, or a combination thereof.

Additionally or alternatively to the use of multiple channels in the frequency domain, different directed and spatially separate wireless communication streams (also referred to as non-overlapping in space wireless communication streams) can be used to support parallel transmission of multiple sensing PPDUs, parallel reporting of sensing results, or a combination thereof. The different communication streams correspond to different beams between transmit and receive antennas, which allow for separation of different communications in order to support such parallel occurrences. In such embodiments, at least the initiator may have two antennas (with two different antenna/sector/beam IDs) which are configured to communicate with different responders. As an example, different transmit (Tx) and receive (Rx) antenna pairs may be employed for this purpose. Other types of MU-MIMO or similar spatial or antenna diversity approach may be employed to achieve separation of communication streams. Wireless communication signals links can be non-overlapping in space (as spatially separated streams), as above, in frequency (as frequency separated sub-channels), or both. Both methods can be used to separate signals to facilitate parallel transmissions in time.

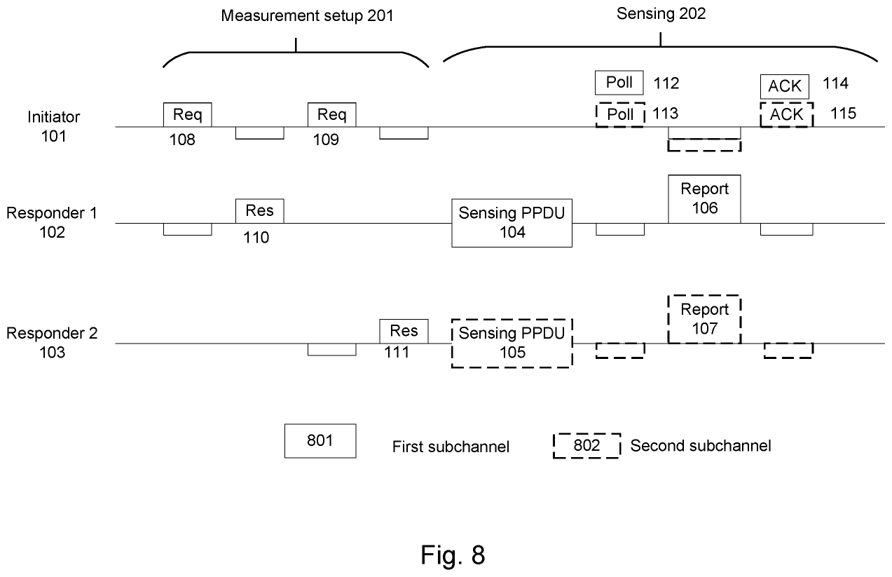

FIG. 8 illustrates a procedure of coordinated monostatic sensing with responders 102 and 103 conducting monostatic sensing measurement in parallel over two sub-channels. The measurement setup phase 201 of this procedure is identical in form to the one disclosed in FIG. 2. Request frames 108 and 109 and response frames 110 and 111 are exchanged between initiator 101 and responders 102 and 103 sequentially over sub-channel 801. During the sensing phase 202, responder 102 transmits and receives sensing PPDU 104 over a first sub-channel 801. Responder 103 transmits and receives sensing PPDU 105 over a second sub-channel 802 in parallel with sensing PPDU 104. Thus, each responder uses its own respective sub-channel for its own respective sensing PPDU transmission and reception. Here and elsewhere below (and as also explained above) two different sub-channels may be different with respect to carrier frequency and non-overlapping in the frequency domain. Each sensing responder (102 or 103) may transmit more than one sensing PPDU. For example, a sensing responder (or in other cases, sensing initiator) may transmit a burst of sensing PPDUs for coverage purposes. Measurement reports 106 and 107 are provided by the responders 102 and 103 to initiator 101 in parallel (in time) over different sub-channels 801 and 802 respectively. Thus, the different responders use different sub-channels for the reporting. Poll (112 and 113), measurement report (106 and 107) and ACK (114 and 115) frames are exchanged between the initiator 101 and the responders 102 and 103 in parallel over sub-channels 801 and 802. One or more of the poll, report and ACK frames may be transmitted in parallel with another respective poll, report or ACK frame corresponding to communication of another initiator-responder pair. This disclosed embodiment may provide for more efficient transmissions of measurement reports.

Here and elsewhere herein, receiving a sensing PPDU includes measuring a corresponding channel or sub-channel based on the detected sensing PPDU, as part of obtaining measurements of such channel or sub-channel. This obtaining measurements is done in order to estimate physical characteristics of an object, as described elsewhere above. Measurement reports include information obtained from the responders' measurements (based on the detected/received sensing PPDUs) to the initiator.

Here and elsewhere herein, sub-channels used for sensing are also described as being used for subsequent reporting. This is considered to align well with current IEEE channel assignment operations. However, it is contemplated that the sub-channels used for sensing could potentially be different than those used for reporting.

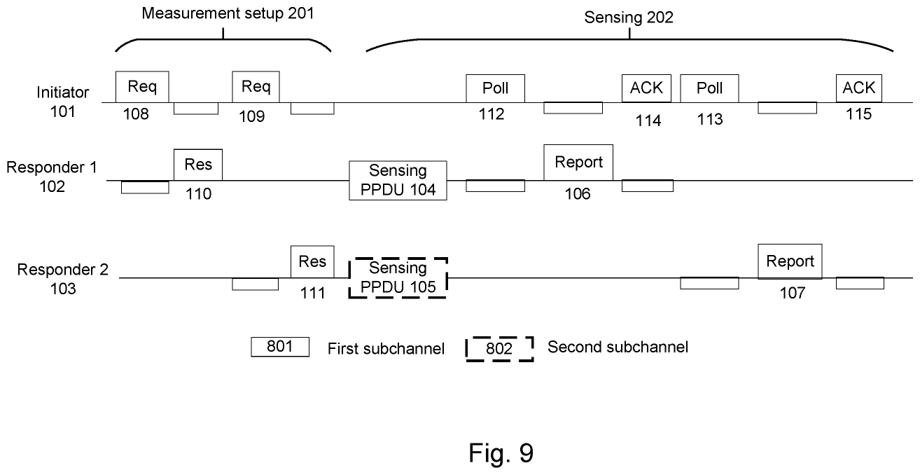

FIG. 9 illustrates another procedure of efficient coordinated monostatic sensing wherein parallel (in time) sensing measurements are conducted over two different sub-channels. The measurement setup phase 201 in this procedure is identical in form to the one disclosed in FIG. 2. Request (108 and 109) and Response (110 and 111) frames are exchanged between initiator 101 and responders 102 and 103 sequentially over first sub-channel 801. During the sensing phase 202, sensing PPDUs 104 and 105 are used for sensing over sub-channels 801 and 802 respectively. Sensing PPDU 104 and 105 are transmitted and received by responders 102 and 103 in parallel, the same as for FIG. 8. Poll (112 and 113), measurement report (106 and 107) and ACK (114 and 115) frames are exchanged between initiator 101 and responders 102 and 103 sequentially over first sub-channel 801. Thus, sensing is performed in parallel and reporting is sequential (so that each responder performs reporting at a different respective time, with the initiator also prompting (polling for) and acknowledging reporting for different responders at different times). The sub-channels used for reporting by each responder may be the same, or the responders may each use different sub-channels for reporting. Such an embodiment may improve accuracy due to parallel sensing, while using a different reporting scheme for greater applicability in some cases.

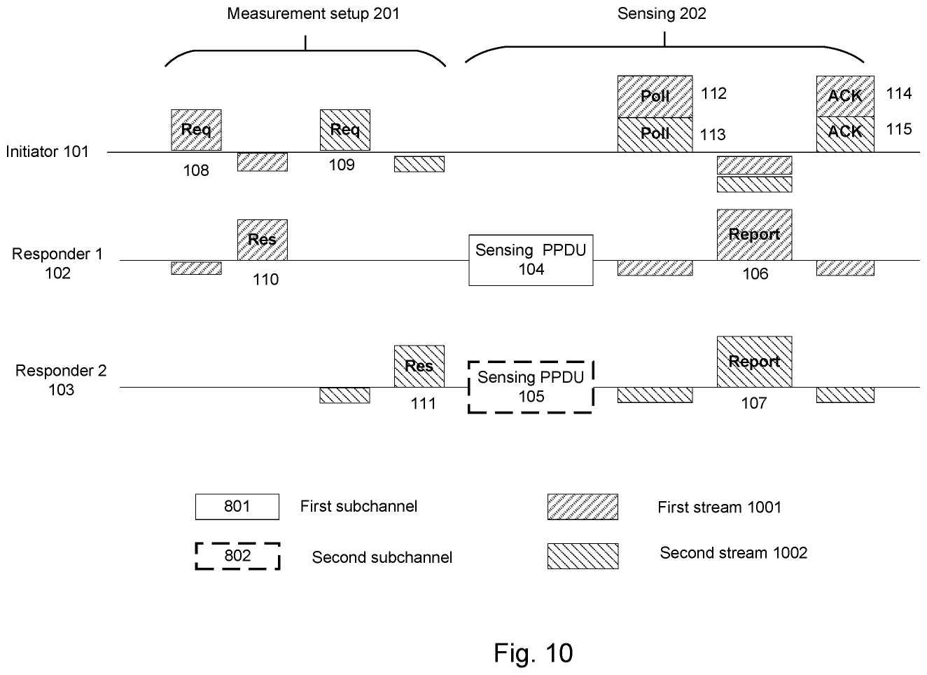

Some other embodiments may have each of the sensing responders reporting respective information (for example, measurement reports) to the sensing initiator using a different respective directed and spatially separate wireless communication stream (also referred to herein as a path). Such embodiments are described for example with respect to FIGS. 10, 11, 14, 15, 17. In such embodiments or other embodiments (e.g. as in FIG. 19), each of the sensing responders may communicate with the sensing initiator, as a part of setting up object sensing measurement, using the different respective directed and spatially separate wireless communication streams. Alternatively, setting up the object sensing measurement does not necessarily require using different directed and spatially separate wireless communication streams. Initiator 101, disclosed in FIG. 1, may have two antennas (with two different antenna/sector/beam IDs) to communicate with responders 102 and 103, respectively. Initiator 101 with two antennas may facilitate uplink (UL)/downlink (DL) MU-MIMO functionality.

FIG. 10 illustrates a procedure of efficient monostatic sensing performed in parallel over two different sub-channels, and with parallel sensing reporting through MU-MIMO. During the measurement setup phase 201, request (108 and 109) and response (110 and 111) frames are exchanged between the initiator 101 and responders 102 and 103 through different respective directed and spatially separate wireless communication streams 1001 and 1002 for each initiator-responder pair. For example, such frames may be exchanged through a respective first Tx-Rx antenna pair and second Tx-Rx antenna pair over a single (common) sub-channel. The frames' exchange is sequential. Other than the use of such separate wireless communication streams or associated links to communicate between initiator and responders to set up object sensing measurement, the measurement setup phase 201 may be similar in form to that of FIG. 2. During the sensing phase 202, sensing PPDUs 104 and 105 are transmitted over two different sub-channels 801 and 802 in parallel, similarly to FIGS. 8 and 9. Sensing PPDUs (frames) 104 and 105 are transmitted and received by responders 102 and 103 respectively. Poll (112 and 113), measurement report (106 and 107) and ACK (114 and 115) frames are exchanged between initiator 101 and responders 102 and 103 in parallel, similar to FIG. 8. However, rather than using different (in frequency) sub-channels as in FIG. 8, in FIG. 10, parallel transmission of measurement reports is facilitated by use (by the responders and initiator) of the different directed and spatially separate wireless communication streams 1001 and 1002. For example, their frames may be transmitted by different Tx-Rx antenna pairs over a single sub-channel implementing MU-MIMO functionality. Application of multiple spatially separate wireless communication streams (or associated Tx-Rx antenna pairs) may provide for more efficient transmission of measurement reports.

In more detail, the initiator may transmit Polling, ACKs, or both, in parallel to each responder using a respective one of the directed and spatially separate wireless communication streams 1001, 1002, where such transmission uses the stream in reverse relative to the stream as viewed from responder to initiator. The responders may transmit their reports in parallel to the initiator in parallel using these streams.

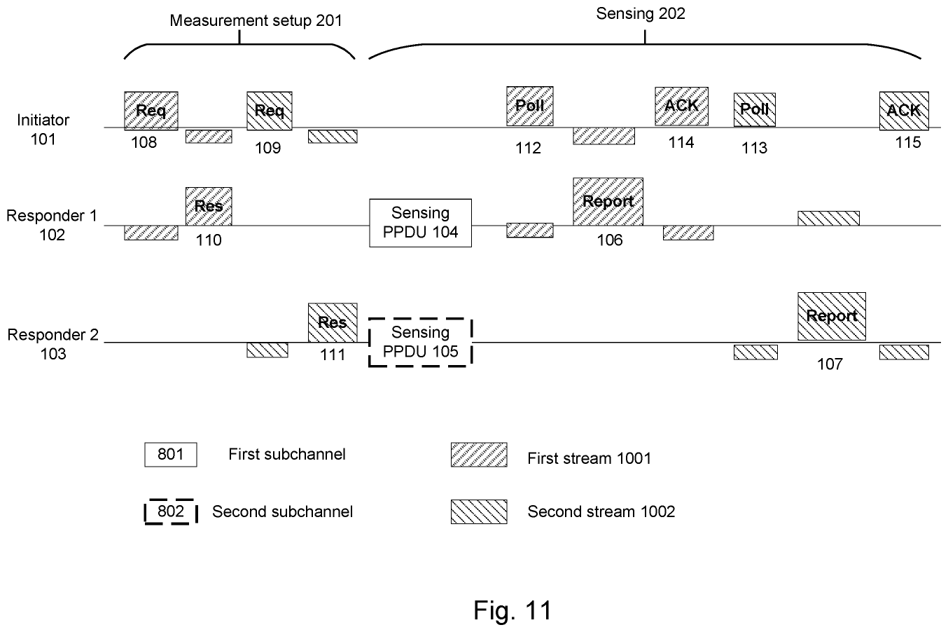

FIG. 11 illustrates a procedure of efficient monostatic sensing performed with operations of parallel sensing measurement over sub-channels 801 and 802, and with different respective directed and spatially separate wireless communication streams being used during measurement setup and reporting. This procedure may be used for example without DL/UL MU-MIMO functionality being implemented during measurement reporting to initiator 101. The Initiator 101 may have two antennas with two different antenna/sector/beam IDs. The measurement setup phase 201 of this procedure is identical in form to the one disclosed in FIG. 10. During the sensing phase 202, which is also the same as in FIG. 10, sensing PPDU 104 and 105, used for measurement of the channels, are transmitted by the responders in parallel over two different sub-channels 801 and 802 and received by responders 102 and 103 respectively. Reporting is sequential, for example such that poll, measurement report and ACK frames are exchanged between initiator 101 and responders 102 and 103 sequentially. The reporting may be performed over a single sub-channel. The frames' exchange between initiator 101 and responders 102 and 103 is conducted through the different respective directed and spatially separate wireless communication streams 1001 and 1002, for example corresponding to different Tx-Rx antenna pairs. The embodiments of monostatic sensing disclosed in FIGS. 8-11 may provide for more efficient transmission of multiple sensing PPDUs and more accurate coordination measurement when combining measurement results from responders 102 and 103.

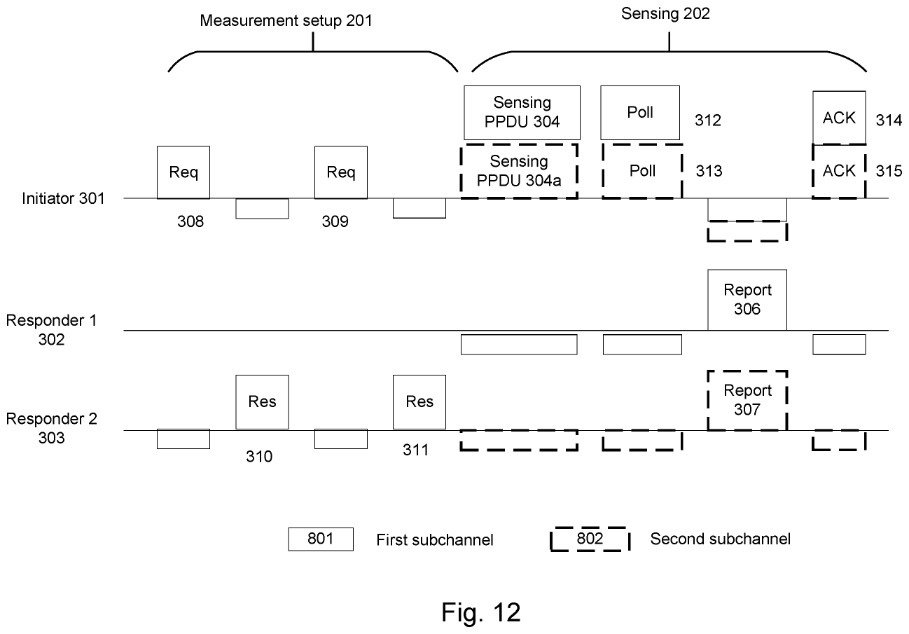

FIG. 12 illustrates a procedure of efficient coordinated bistatic sensing with operations of parallel sensing measurement and parallel measurement reporting performed over two sub-channels, in parallel. Multiple sensing PPDUs are transmitted by the sensing initiator in parallel in time (e.g. simultaneously) with one another. Each of the sensing PPDUs is transmitted on a different respective one of a plurality of sub-channels which are at different frequencies. In this embodiment, initiator 301 may have a single antenna (either a quasi-omni antenna or a directional antenna with a specific antenna/sector/beam ID) to communicate with responder 302 and 303 in parallel. Initiator 301 may alternatively have two or more antennas. Measurement setup phase 201 of this embodiment is identical in form to the one disclosed in FIG. 2 (except for the numbering of the frames). During sensing phase 202, sensing initiator 301 cooperates with sensing responders 302 and 303 by transmitting sensing PPDU 304 for receipt by the first sensing responder 302 and sensing PPDU 304a for receipt by the second sensing responder 303. Sensing PPDU 304 and 304a are transmitted in parallel for reception by responders 302 and 303 through a first sub-channel 801 and a second sub-channel 802, respectively, so that each responder performs its own respective sensing PPDU reception (and associated measurements) using a different sub-channel. Sub-channels 801 and 802 are different from one another with respect to carrier frequency and are non-overlapping in frequency domain. Sensing PPDUs 304 and 304a are used for measurement of the channels and transmitted over sub-channels 801 and 802 in parallel in time. Sensing PPDUs 304 and 304a are received by responders 302 and 303, respectively. Responders 302 and 303 obtain measurements of sub-channels 801 and 802 in order to estimate one or more physical characteristics of object 100 based on receipt of (e.g. due to interaction with) their respectively received sensing PPDUs.

A sensing initiator may transmit to each one of the plurality of sensing responders a respective poll 312, 313 requesting reporting respective information. The sensing initiator may also transmit a respective acknowledgement (ACK 314, 315) which acknowledges the reporting 306, 307 of the respective information. Each respective polling signal, each respective acknowledgement (ACK), or both, may be transmitted in parallel using a different sub-channel. Poll, reports and acknowledgements corresponding to interaction with a same sensing responder may use a same sub-channel or set of different sub-channels. For example, in this embodiment poll, measurement report, and ACK frames are exchanged between initiator 301 and responders 302 and 303 in parallel (e.g. simultaneously) over sub-channels 801 and 802. The different responders, in cooperation with the initiator, use different sub-channels for reporting (e.g. including poll, report and ACK frames), thus facilitating parallel reporting (e.g. of at least one of the poll, report and ACK frames), similarly to FIG. 8. Disclosed in this embodiment measurement reporting may provide for more efficient transmission of measurement reports.

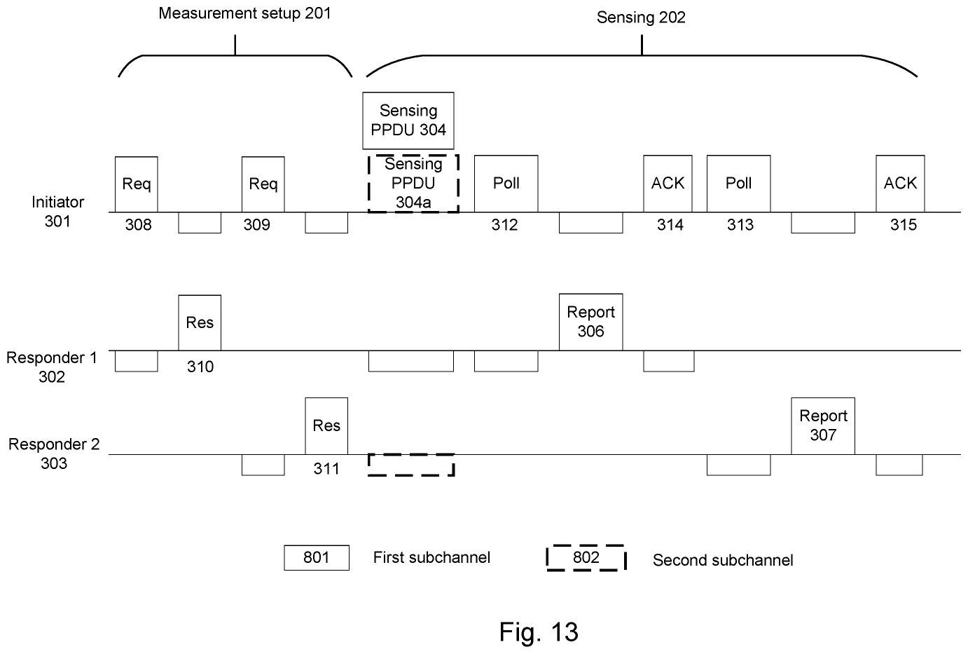

FIG. 13 shows another procedure of coordinated bistatic sensing performed with parallel bistatic sensing measurement over two sub-channels. Initiator 301 may use a single antenna (a quasi-omni antenna or a directional antenna with a specific antenna/sector/beam ID) to communicate with responder 302 and 303, in parallel. Measurement setup phase 201 is identical in form to the one disclosed in FIG. 2 (except for the numbering of the frames). During sensing phase 202, initiator 301 cooperates with responders 302 and 303 by transmitting, with respect to each of the responders sensing PPDU 304 and 304a. Sensing PPDU 304 and 304a are received by the responders 302 and 303 through sub-channels 801 and 802 respectively, similarly to the embodiment of FIG. 12. Sub-channels 801 and 802 are different from one another with respect to carrier frequency and non-overlapping in frequency domain. Sensing PPDU 304 and 304a are used for measurement of the channels and transmitted over sub-channels 801 and 802 in parallel. Sensing PPDU 304 and 304a are received by responders 302 and 303, respectively. Responders 302 and 303 obtain measurements of sub-channels 801 and 802 to estimate one or more physical characteristics of object 100 due to interaction with sensing PPDUs. Poll, measurement report and ACK frames are exchanged between initiator 301 and responders 302 and 303 sequentially over sub-channel 801 (for example), to achieve sequential reporting similarly to FIG. 9.

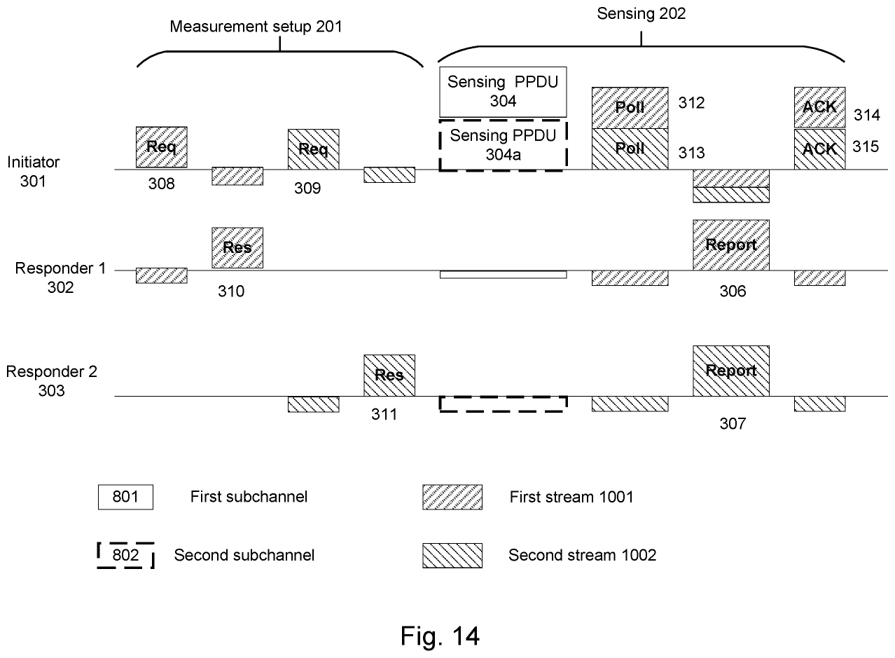

FIG. 14 illustrates yet another procedure of efficient coordinated bistatic sensing performed with operations of parallel sensing measurement over two sub-channels and with parallel sensing reporting through MU-MIMO. In this embodiment initiator 301 may have two antennas (having two different antenna/sector/beam IDs) to communicate with responders 302 and 303. Sensing PPDU 304 and 304a are transmitted through either one antenna or multiple antennas in parallel. Initiator 301 with multiple antennas may facilitate uplink (UL)/downlink (DL) MU-MIMO functionality. Measurement setup phase 201 of this procedure is identical in form to the one, disclosed in FIG. 10 and respective description(thus utilizing different directed and spatially separate wireless communication streams for communication between each initiator-responder pair). During sensing phase 202, sensing PPDU 304 and 304a are transmitted over different sub-channels 801 and 802 in parallel in time, similarly to FIGS. 12 and 13. Sensing PPDUs (frames) 304 and 304a are transmitted by the initiator and received by responders 302 and 303 respectively. Poll (312 and 313), measurement report (306 and 307) and ACK (314 and 315) frames are exchanged between initiator 301 and responders 302 and 303 in parallel in time, similarly to FIG. 10. The poll, report and ACK frames may be transmitted by different Tx-Rx antenna pairs over a single sub-channel implementing MU-MIMO functionality as shown in FIG. 14. More generally, the poll, report and ACK frames may be transmitted via different directed and spatially separate wireless communication streams 1001, 1002, so that the responders perform reporting in parallel via such streams. Application of multiple Tx-Rx antenna pairs or spatially separate wireless communication streams 1001, 1002 may provide for more efficient transmission of measurement reports.

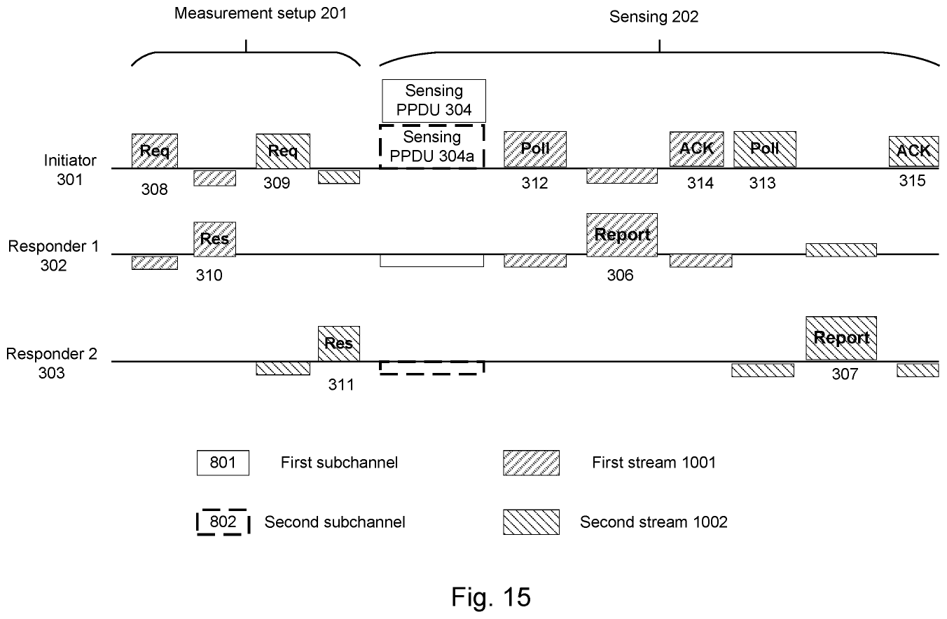

FIG. 15 presents a procedure of efficient coordinated bistatic sensing performed with operations of parallel bistatic sensing measurement over two sub-channels. As in the previous embodiment, initiator 301 may have two or more antennas (having two or more different antenna/sector/beam IDs) to communicate with responders 302 and 303. Sensing PPDU 304 and 304a are transmitted through either one antenna or multiple antennas in parallel. Measurement setup phase 201 of the procedure is identical in form to the one, disclosed in FIG. 10 and respective description. During sensing phase 202, sensing PPDU 304 and 304a are transmitted over sub-channels 801 and 802 in parallel, similarly to FIGS. 12 to 14. Sensing frames 304 and 304a are transmitted by the initiator 301 and received by responders 302 and 303 respectively. Poll (312 and 313), measurement report (306 and 307) and ACK (314 and 315) frames are exchanged between initiator 301 and responders 302 and 303 sequentially for example over a single sub-channel (in frequency), similarly to FIG. 11, to achieve sequential reporting. The poll, report and ACK frames exchanged between initiator 301 and responders 302 and 303 may be conducted through different Tx-Rx antenna pairs respectively. More generally, the poll, report and ACK frames may be transmitted via different directed and spatially separate wireless communication streams 1001, 1002. The disclosed embodiments of bistatic sensing disclosed in FIGS. 12-15 may provide for more efficient transmission of multiple sensing PPDUs and more accurate coordination measurement when combining measurement results from responders 302 and 303. Multiple sensing PPDUs are transmitted concurrently to improve sensing accuracy and shorten sensing time. Reporting may be parallelized in time to shorten the time requirements for reporting, although this is not necessary in all embodiments.

FIG. 16 shows a procedure of efficient multistatic sensing with parallel sensing measurement reporting over two sub-channels. In this embodiment initiator 501 may possibly have a single antenna (either the quasi-omni antenna or directional antenna with a specific antenna/sector/beam ID) to communicate with responder 502 and 503. Measurement setup phase 201 is identical in form to the one, disclosed in FIG. 2 (except for the numbering of the frames). A multistatic sensing PPDU 504, used for measurement of the channels, is transmitted over sub-channel 801, and received by responders 502 and 503. Each responder measures the same sub-channel for PPDU reception and associated measurements (for estimating object physical characteristics). Poll, measurement report and ACK frames are exchanged between initiator 501 and responders 502 and 503 in parallel in time over sub-channels 801 and 802 of different frequencies, similarly to FIGS. 8 and 12. As such, the responders may report sensing results to the sensing initiator concurrently, or at least without timing constraints with respect to one anothers' transmissions. The initiator's communication to the responders in association with such reporting can also be done concurrently or at least without timing constraints with respect to the initiator's transmissions to each responder. Parallel measurement reporting, implemented in this embodiment by having each responder use a different respective sub-channel for reporting, may provide for more efficient or timely transmission of measurement report frames.

FIG. 17 discloses another procedure of efficient multistatic sensing with parallel measurement reporting. In this embodiment, initiator 501 may have two or more antennas (with two or more different antenna/sector/beam IDs) to communicate with responders 502 and 503. Initiator 501 with two or more antennas may facilitate uplink (UL)/downlink (DL) MU-MIMO functionality. More generally, the initiator 501 may communicate with each responder 502, 503 (and vice-versa) via different respective and spatially separate wireless communication streams 1001, 1002. Measurement setup phase 201 of this procedure is identical in form to the ones disclosed in FIGS. 10, 14 and 15 and respective description. Single sensing PPDU 504, used for measurement of the channels, is transmitted over a single sub-channel and received by responders 502 and 503, similarly to FIG. 16. Poll (512 and 513), measurement report (506 and 507) and ACK (514 and 515) frames are exchanged between initiator 501 and responders 502 and 503 in parallel in time. The frames may be transmitted by different Tx-Rx antenna pairs over a single (in frequency) sub-channel by implementing MU-MIMO functionality. More generally, the poll, report and ACK frames may be transmitted via the different respective directed and spatially separate wireless communication streams 1001, 1002, thus allowing for parallelization of reporting in time without necessarily using different-frequency sub-channels (although such different sub-channels could optionally be employed), similarly to FIG. 14. Application of multiple different directed and spatially separated wireless communication streams 1001 and 1002, for example implemented by using multiple different Tx-Rx antenna pairs, may provide for more efficient or timely transmission of measurement reports. FIGS. 16 and 17 illustrate two different approaches for parallelizing the sensing reporting in time, i.e. via either use of different-frequency sub-channels or different wireless communication streams.

FIG. 18 shows a procedure of efficient multistatic sensing with parallel multistatic sensing measurement over two sub-channels. In this embodiment, each of the plurality of sensing responders (for example, 502a or 503a) transmits one or more of the sensing PPDUs. In this embodiment initiator 501a may have a single antenna (either a quasi-omni antenna or a directional antenna with a specific antenna/sector/beam ID) to receive reflected PPDUs, transmitted by responders 502a and 503a. Initiator 501a obtains measurements of each of the different respective sub-channels in order to receive the sensing PPDUs and obtain measurements of each sub-channel in order to estimate physical characteristics of the sensed object based on receipt of the sensing PPDUs. Measurement setup phase 201 of this embodiment is identical in form to the one, disclosed in FIG. 2 (except for the numbering of the frames). During sensing phase 202, sensing PPDU 504a and 505a are transmitted over different-frequency sub-channels 801 and 802 in parallel in time by responders 502a and 503a respectively. The initiator receives the sensing PPDUs via both of these sub-channels in parallel in time. Sensing frames 504a and 505a are received by initiator 501a. There is no requirement for sensing reporting as the initiator performs the measurements itself.

FIG. 19 shows yet another procedure of efficient multistatic sensing performed with operations of parallel multistatic sensing over two sub-channels. Initiator 501a may have two antennas (with two different antenna/sector/beam IDs) to communicate with responders 502a and 503a. Measurement setup phase 201 in this procedure is identical in form to the ones disclosed in FIGS. 10, 14, 15 and 17 and respective description. Sensing phase 202 is identical in form to the one disclosed in the previous embodiments (FIG. 18). The embodiments disclosed in FIGS. 18-19 may provide for efficient transmission of multiple sensing PPDUs and more accurate coordination of measurement when combining measurement results. Furthermore, these embodiments provide an approach to multistatic sensing in which responders transmit sensing PPDUs for receipt by a same initiator, with the sensing PPDUs being transmitted in parallel in time, thus improving sensing performance by avoiding the need for sequential sensing PPDUs (which could introduce inaccuracies due to time-varying channel conditions).

In monostatic, bistatic and multistatic sensing, request and response frames, exchanged between the initiator and the responders, may provide allocation of sub-channel information for each responder in order to conduct multiple sub-channel operations during a sensing phase (including sensing measurement and sensing reporting). The request and response frames, exchanged between the initiator and the responders, may also provide the starting time for parallel sensing measurements over multiple sub-channels. Thus, although the measurement setup phase 201 in embodiments of the present disclosure may be identical or substantially identical in form to the measurement setup phase in other approaches, the information exchanged between initiator and responders during this measurement setup phase 201 may be different in embodiments of the present disclosure, compared to other approaches. The measurement setup phase is the phase during which the sensing initiator wirelessly communicates with sensing responders to set up an object sensing measurement. Thus, the measurement setup phases for different embodiments may be identical or similar in form, but different in content. Information indicative of the different-frequency sub-channels to be used, the parallelization or non-parallelization in time (or other timing aspects) of various transmissions, the designation of different directional and spatially separate wireless communication streams, etc. can be communicated as required during the measurement setup phase 201.

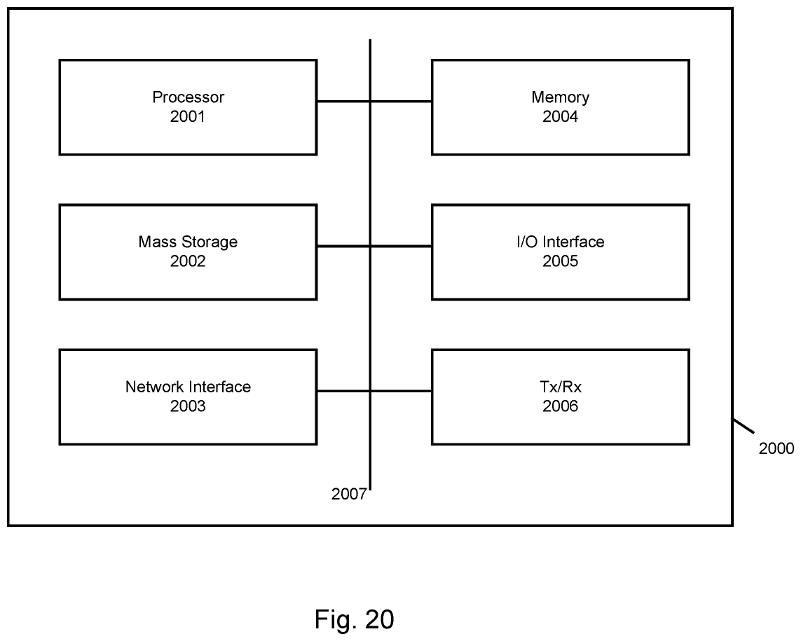

FIG. 20 is a block diagram of an electronic device 2000 denoted in the present disclosure as a sensing initiator or a sensing responder. Device 2000 may wirelessly communicate with one or more other devices to set up an object sensing measurement, wherein device 2000 and the one or more other devices constitute a sensing initiator and one or more sensing responders. Device 2000 may be a device in a multi-master system. Device 2000 may comprise a computer processor operatively coupled to a computer memory. A computer equipped with network function including wireless transceiver may be configured as device 2000. Device 2000 may correspond to parts of a computer server, or a network node providing network access (e.g., an IEEE 802.11 access point (AP) or similar device), or a network node accessing a network, e.g. an IEEE 802.11 wireless station (STA). In some embodiments an initiator is an AP or a STA, and each responder is also an AP or a STA. APs and STAs may be wirelessly coupled via a wireless local area network (WLAN) such as an IEEE 802.11 compliant WLAN, with various PPDUs, frames and other communications as described herein being communications following such IEEE 802.11 protocols.

As shown in FIG. 20, device 2000 includes a processor 2001, such as a Central Processing Unit (CPU) or specialized processors such as a Graphics Processing Unit (GPU) or other such processor unit, memory 2004, non-transitory mass storage 2002, I/O interface 2005, network interface 2003, and wireless transceiver 2006, all of which are communicatively coupled via bi-directional bus 2007. Transceiver 2006 includes one or multiple antennas. According to certain embodiments, any or all of the depicted elements may be utilized, or only a subset of the elements. Further, device 2000 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

Memory 2004 may include any type of non-transitory memory such as static random access memory (SRAM), dynamic random access memory (DRAM), synchronous DRAM (SDRAM), read-only memory (ROM), any combination of such, or the like. Mass storage element 2002 may include any type of non-transitory storage device, such as a solid state drive, hard disk drive, a magnetic disk drive, an optical disk drive, USB drive, or any computer program product configured to store data and machine executable program code. According to certain embodiments, memory 2004 or mass storage 2002 may have recorded thereon statements and instructions executable by the processor 2001 for performing any of the aforementioned method operations described above.

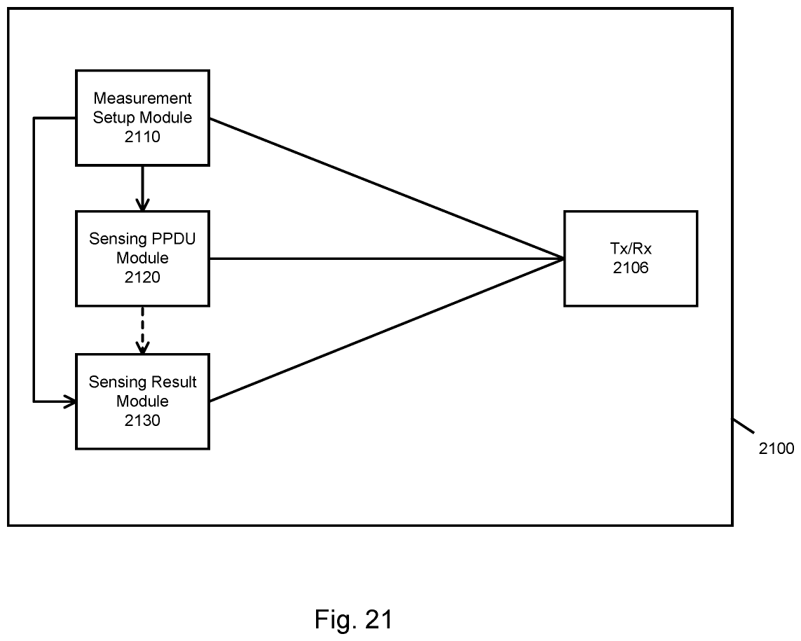

FIG. 21 illustrates an electronic device 2100, according to an embodiment of the present disclosure. The electronic device 2100 may be a sensing initiator or sensing responder, and may include components and aspects of the device 2000 as described above. The device includes a transmitter and receiver 2106, which may transmit and receive PPDUs and/or frames in accordance with an IEEE 802.11 protocol. The electronic device further includes a measurement setup module 2110, a sensing PPDU module 2120 and a sensing result module 2130. These modules may be functional aspects of the device, for example as implemented by a same computer processor or common electronics, or by separate or partially separate processors or electronics. The modules 2110, 2120, 2130 may operate differently depending on whether the device 2100 is acting as a sensing initiator or a sensing responder, as well as the type of sensing operation being performed (e.g. monostatic, bistatic or multistatic). The modules 2110, 2120, 2130 and transmitter and receiver 2106 cooperate to perform a device's portion of operations as described in the various embodiments above, where the device is a sensing initiator or sensing responder. Multiple such devices can interact to provide a system of devices configured to perform sensing operations.

The measurement setup module 2110 operates to set up a sensing measurement by communicating with other similar devices via the transmitter and receiver 2106. That is, the measurement setup module 2110 may perform the device's portion of communications as described above with respect to the measurement setup phase 201. When the device 2100 is a sensing initiator, the measurement setup module may further determine the type of sensing to be performed, the sensing responders to be used, etc. The measurement setup module 2110 configures the sensing PPDU module 2120 and the sensing result module 2130. Such configuration may be based on information obtained during measurement setup. For example, the measurement setup module 2110 may configure which sub-channels to use to send or receive sensing PPDUs and at what time(s), which sub-channels or streams to use to send or receive poll, report and ACK frames and at what time(s), etc.

The sensing PPDU module 2120 configures and causes the transmitter and receiver 2106 to send, receive or both send and receive sensing PPDUs as described above with respect to the first part of the sensing phase 202. The sensing PPDU module may direct aspects of transmission, reception or both, such as contents of the sensing PPDU, timing, and sub-channel used.

The sensing result module 2130 operates to perform the device's portion of communications as described above with respect to the second part of the sensing phase 202. This may include (in cooperation with the transmitter and receiver 2106) sending or receiving, as appropriate, poll, report and acknowledgement frames. Such frames can also be generated and configured, or processed, as appropriate, by the sensing result module 2130. The sensing result module 2130 can generate and provide contents of sensing report frames transmitted to other devices, for example based on information received from the sensing PPDU module 2120. The sensing result module 2130 can receive sensing report frames from other devices and generate sensing results, e.g. object-related information, based at least in part on such sensing reports. Additionally or alternatively the sensing result module 2130 can generate sensing results, based at least in part on information obtained from the sensing PPDU module 2120.

It is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology. Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device. Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method for sensing an object using wireless signals, comprising, by a sensing initiator:
wirelessly communicating with a plurality of sensing responders to set up an object sensing measurement;
transmitting, to each of the sensing responders, or receiving from each of the sensing responders, a different respective sensing PPDU on a different respective one of a plurality of sub-channels, the different respective sensing PPDUs being transmitted in parallel in time, the different respective sub-channels differing from one another with respect to carrier frequency and being non-overlapping in frequency domain; and
obtaining indications of measurements of the plurality of sub-channels based on receipt of the sensing PPDUs by the sensing initiator, or based on receipt of reports from the plurality of sensing responders, the reports generated based on receipt of the sensing PPDUs, the indications of measurements usable to estimate one or more physical characteristics of the object.

2. The method of claim 1, wherein:
said reports from the plurality of sensing responders comprise a different respective report from each one of the plurality of sensing responders, each of the different respective reports received using a different respective one of the plurality of sub-channels; and
said different respective reports are received in parallel in time.

3. The method of claim 1, wherein the sensing initiator transmits each one of the sensing PPDUs, and each of the plurality of sensing responders measures one of the different respective sub-channels to receive its respective sensing PPDU to obtain said measurements with respect to said one of the different respective sub-channels.

4. The method of claim 1, wherein transmitting each of the different respective sensing PPDUs in parallel comprises transmitting each of the different respective sensing PPDUs with at least partially overlapping timing with at least one other of the different respective sensing PPDUs.

5. The method of claim 2, wherein the different respective reports received in parallel are transmitted by the plurality of sensing responders with at least partially overlapping timing.

6. The method of claim 2, further comprising transmitting, to each one of the plurality of sensing responders, a respective polling signal for one of said reports, a respective acknowledgement of one or said reports, or both, wherein each respective polling signal, each respective acknowledgement, or both, is transmitted in parallel in time using the different one of the plurality of sub-channels used by the one of the different sensing responders to transmit its respective report.

7. The method of claim 1, wherein:
said reports from the plurality of sensing responders comprise a different respective report from each one of the plurality of sensing responders, each of the different respective reports received using a different respective directed and spatially separate wireless communication stream.

8. The method of claim 7, wherein said different respective reports are received in parallel in time.

9. The method of claim 8, further comprising transmitting, to each one of the plurality of sensing responders, a respective polling signal for one of said reports, a respective acknowledgement of one of said reports, or both, wherein each respective polling signal, each respective acknowledgement, or both, is transmitted in parallel in time using, in reverse, the different respective directed and spatially separate wireless communication stream used by the one of the plurality of sensing responders to transmit its respective report.

10. The method of claim 1, wherein wirelessly communicating with the plurality of sensing responders to set up the object sensing measurement comprises communicating with each one of the sensing responders using a different respective directed and spatially separate wireless communication stream.

11. A method for sensing an object using wireless signals, comprising, by a sensing responder:
wirelessly communicating with a sensing initiator to set up an object sensing measurement, the object sensing measurement involving the sensing initiator, the sensing responder, and one or more other sensing responders; and
transmitting a sensing PPDU on one of a plurality of sub-channels, the sensing PPDU transmitted in parallel in time with one or more other sensing PPDUs each transmitted by a respective one of the other sensing responders on another one of the plurality of sub-channels, the plurality of sub-channels differing from one another with respect to carrier frequency and being non-overlapping in frequency domain.

12. The method of claim 11, further comprising obtaining measurements of said one of the plurality of sub-channels in order to estimate one or more physical characteristics of the object based on receipt of the sensing PPDU, and reporting an indication of said measurements to the sensing initiator.

13. The method of claim 12, wherein:
each of the one or more other sensing responders reports respective indications of measurements in relation to the object, based on receipt of a respective one of the other sensing PPDUs to the sensing initiator;
the sensing responder reports its indication of said measurements using one of the plurality of sub-channels, and each of the one or more other sensing responders uses another respective one of the plurality of sub-channels for reporting its respective indication of measurements; and
said reporting the indication of measurements by the sensing responder and each of the one or more other sensing responders is performed in parallel in time.

14. The method of claim 11, wherein transmitting each of the different respective sensing PPDUs in parallel comprises transmitting each of the different respective sensing PPDUs with at least partially overlapping timing with at least one other of the different respective sensing PPDUs.

15. The method of claim 13, wherein said reporting the respective information in parallel by the sensing responder and each of the one or more other sensing responders comprises reporting the respective information with at least partially overlapping timing with said reporting the respective information by at least one other of the sensing responders respective information.

16. The method of claim 12, wherein:
each of the one or more other sensing responders reports respective indications of measurements in relation to the object, based on receipt of a respective one of the other sensing PPDUs to the sensing initiator; and
the sensing responder and each of the one or more other sensing responders reports its indication of said measurements using a different respective directed and spatially separate wireless communication stream.

17. The method of claim 16, wherein said reporting the indications of measurements by the sensing responder and each of the one or more other sensing responders is performed in parallel in time by each of the sensing responders.

18. A sensing initiator apparatus for sensing an object using wireless signals, the apparatus configured to:
wirelessly communicate with a plurality of sensing responders to set up an object sensing measurement;
transmit, to each of the sensing responders, or receive from each of the sensing responders, a different respective sensing PPDU on a different respective one of a plurality of sub-channels, the different respective sensing PPDUs being transmitted in parallel in time, the different respective sub-channels differing from one another with respect to carrier frequency and being non-overlapping in frequency domain; and
obtain indications of measurements of the plurality of sub-channels based on receipt of the sensing PPDUs by the sensing initiator, or based on receipt of reports from the plurality of sensing responders, the reports generated based on receipt of the sensing PPDUs, the indications of measurements usable to estimate one or more physical characteristics of the object.

19. A sensing responder apparatus for sensing an object using wireless signals, apparatus configured to:
wirelessly communicate with a sensing initiator to set up an object sensing measurement, the object sensing measurement involving the sensing initiator, the sensing responder, and one or more other sensing responders; and
transmit a sensing PPDU on one of a plurality of sub-channels, the sensing PPDU transmitted in parallel in time with one or more other sensing PPDUs each transmitted by a respective one of the other sensing responders on another one of the plurality of sub-channels, the plurality of sub-channels differing from one another with respect to carrier frequency and being non-overlapping in frequency domain.

20. The apparatus of claim 19, further configured to obtain measurements of said one of the plurality of sub-channels in order to estimate one or more physical characteristics of the object based on receipt of the sensing PPDU, and report an indication of said measurements to the sensing initiator.
